(19) United States
(12) Patent Application Publication
(10) Pub. No.: US 2023/0359196 A1
(43) Pub. Date: Nov. 9, 2023

(54) COMMUNICATION AND CONTROLS SYSTEM FOR PERIPHERAL EQUIPMENT IN AGRICULTURAL TOOLS AND COMMUNICATION AND CONTROL METHOD FOR PERIPHERAL EQUIPMENT USED IN AGRICULTURAL TOOLS

(71) Applicant: Jose Roberto do Amaral Assy, Caldas Novas (BR)

(72) Inventors: Jose Roberto do Amaral Assy, Caldas Novas (BR); Igor Luiz Bastos de Almeida, Sao Paulo (BR); Luis Otavio Lamardo Alves Silva, Sao Paulo (BR)

(21) Appl. No.: 18/246,913

(22) PCT Filed: Sep. 28, 2021
(86) PCT No.: PCT/BR2021/050417

§ 371 Date: Mar. 28, 2023

(30) Foreign Application Priority Data
Sep. 30, 2020 (BR) BR1020200201166-6

(51) Int. Cl. G05D 1/00; H04L 12/40

(52) U.S. Cl. CPC G05D 1/0022; H04L 12/40; G05D 2201/0201; H04L 2012/40215; H04L 2012/40273

(57) ABSTRACT

Systems and methods for communication and control applied to agricultural machinery and implements, and more specifically communication and control means of peripheral devices applied to row units of planters. The communication and control system for peripheral equipment in agricultural implements may include a human-machine interface, first communication means, a control module, first processing means, second communication means, a remote module, second processing means, and third communication means.

### CROSS REFERENCE TO RELATED APPLICATIONS

This application is a national stage application, filed under 35 U.S.C. § 371, of International Patent Application No. PCT/BR2021/050417, filed 28 Sep. 2021, which claims the benefit of Brazilian Patent Application No. BR 1020020020116-6, filed 30 Sep. 2020, the entire disclosure of each of which is incorporated herein by this reference.

### FIELD

The present disclosure refers to communication and control systems applied to agricultural machinery and implements, more specifically, it refers to communication and control means for peripheral devices used in row units of planters.

### BACKGROUND

Technological applications are increasingly used in the agricultural sector with the aim of optimizing the use of planting fields, making the use of inputs more accurate. Consequently, planting processes become more efficient, so that eventually waste is minimized and the planting results bring greater yields and more profitability to farmers.

When planting large fields, agricultural implements called planters or sowing machines are generally used. These implements are conventionally pulled by tractors and have a plurality of row units, with each row unit using a plurality of peripherals for dosing and controlling the precision of planting.

The control of precision peripherals is commonly done from the tractor cabin where the driver can check the status of each peripheral and send commands to change operating parameters. The communication between the tractor cabin and the peripherals is usually done through cables that run through the entire planter and row units.

Communication through cables running through the entire agricultural implement has some drawbacks, mainly related to manufacturing and maintenance. With regard to manufacturiinvenng, the projects must provide that the path traveled by the tractor cables to the peripherals has numerous joints and junction points that may have gaps, and in these joints and junctions the cable is subject to tensions and frictions arising from the vibrations and normal movement of the planter along the planting fields. In this way, even cabling installed providing for such joints and junctions are subject to the natural wear and tear of movement and, also, to the wear resulting from normal field conditions and weather adversities.

Still, known systems that use cabling have drawbacks in terms of the number of peripherals, since the number of peripherals is limited by the number of cables that can be passed from the tractor to each peripheral.

In addition, wired systems are more restricted in terms of the inclusion of additional peripherals, since there is a need for skilled labor for the passage and installation of a new peripheral. Therefore, the costs and time required to improve the planter often make it impossible to install an additional peripheral.

Technologies are known that use wireless peripheral control systems, at least in part for the path between the tractor and the peripherals. These solutions mainly replace cabling in regions of joints and junctions where they are more prone to wear.

A known document is U.S. Pat. No. 10,548,256 which discloses a wireless agricultural implement control system including a control module, an interface module, and several remote modules, where the control module is provided with a user interface adapted to receive commands. The system disclosed in U.S. Pat. No. 10,548,256 patent provides for wireless communication between modules, thus allowing for reduction in the tension, wear, and breakage of the cables of a planter.

Despite being functional and reducing the wear and tear related to cabling, the solution presented by U.S. Pat. No. 10,548,256 is limited in relation to communication between the remote module and the peripherals, requiring a plurality of remote modules to interact with the same number of peripherals. Thus, for the installation of new peripherals, it is necessary to install a new remote module and all the specific structures and configurations for each new peripheral.

Another known technological solution for communication is CAN (Controller Area Network), also known as “CAN bus”, which is a network standard designed for internal communication between devices inside a vehicle. Although it uses cables, the CAN bus is considered robust for vehicles, as it uses a message-based protocol and uses multiplexing to take advantage of vehicle electrical cabling.

U.S. Patent Publication 2017/0180152 discloses a bridging system between a CAN bus subsystem and a wireless communication module that uses two different wireless communication protocol versions.

Although the system disclosed by U.S. Patent Publication 2017/0180152 allows communication between a CAN bus module and a wireless communication module, this system only involves a communication bridge, not providing for processing between the modules.

In this way, it is evident to a person skilled in the art that, although there are technologies for communication and control of agricultural implements, these solutions are limited to predefined manufacturing sizing and/or make it difficult to add and change peripheral devices.

Therefore, although apparently functional so far, known communication and control systems for agricultural implements have some drawbacks and limitations mainly related to maintenance and installation of new peripheral devices.

### SUMMARY

In order to circumvent the drawbacks of the known systems, the present disclosure deals with a communication and control system for peripheral equipment of agricultural implements, which includes a human-machine interface, a first communication means, a control module, a first processing means, a second communication means, a remote module, a second processing means, and a third communication means.

According to additional or alternative embodiments of the present disclosure, the following features, and possible variants thereof, may also be present, alone or in combination: the first communication means includes a first transceiver in the human-machine interface in communication with a second transceiver in the control module; the second communication means includes a third transceiver in the control module in communication with a fourth transceiver in the remote module; the third communication means includes a fifth transceiver in the remote module in communication with a sixth transceiver in one or more peripherals; the first processing means and the second processing means can generate control signals and messages; the third communication means transmits a message to the peripherals; one of the communication means includes an electromagnetic information transmission system, particularly radio frequency that uses one of the protocols: Bluetooth, Wi-Fi, Lora, Sigfox, proprietary protocol, or mobile networks; the first communication means uses the ISOBUS, CAN-BUS, or proprietary protocol as standard; the system includes at least two peripherals, the peripherals including one of an actuator, sensor, smart sensor, and smart actuator; the actuator is a CAN engine; the actuator is an engine mounted on one of a seed meter, particulate or liquid material meter, depth regulator, conveyor belt, and row unit lifting system; the human-machine interface includes a positioning system and an agricultural calculation system; the control module includes a positioning system and the first processing means; the remote module includes the second processing means; one of the communications means is 2.4 Ghz RF communication with proprietary protocol; each remote module is connected to a Hall motor, an encoder sensor of the Hall motor, and to a CAN bus with one of a CAN engine or a CAN sensor; the CAN engine controls a conveyor belt; and the CAN sensor detects the passage of seeds.

In addition, the present disclosure also deals with a method of communication and control of peripheral equipment applied in agricultural implements, the method including the steps of: receiving an instruction on a human-machine interface; generate a first command message; transmit the command message to the remote modules; interpret the command message in the remote modules; and if the peripheral is a smart actuator, generate a message, and send the message to the smart actuator; if the peripheral is a smart sensor, receive a message, generated by the smart sensor, on the remote module, and interpret the peripheral smart sensor message; if the peripheral is a simple control device, generate a control signal when the peripheral is an actuator and receive a monitoring signal when the peripheral is a sensor.

According to additional or alternative embodiments of the disclosure, the following features, alone or in technically possible combinations, may also be present: the method further includes the steps of transmitting the first command message to a control module; interpreting the first command message and generating a second command message; transmitting the second command message to the remote modules; and interpreting the second command message on the remote modules; the first and second command messages are wireless command messages; the instruction is an ISOBUS message; the method additionally includes the steps of obtaining positioning information by means of a location device; obtain an instruction by means of an agricultural calculating machine; and generate and transmit a command message; the locating device and the agricultural calculating machine can be arranged in the human-machine interface and/or in the control module; and/or the first and second command messages are wireless command messages.

### BRIEF DESCRIPTION OF THE DRAWINGS

The objects, advantages and technical and functional improvements of the present disclosure will be better understood from the following description in relation to particular embodiments, which make reference to the accompanying figures, in which:

FIG. 1 shows a schematic view of an embodiment of the disclosure;

FIG. 2 shows a schematic view of an embodiment of the disclosure;

FIG. 3 shows a schematic view of an embodiment of the disclosure;

FIG. 4 shows a schematic view of the communication of an embodiment of the remote module of the disclosure;

FIG. 5 shows a schematic representation of the communication of a remote module of the prior art; and

FIG. 6 shows a flowchart of an embodiment of the method of the present disclosure.

### DETAILED DESCRIPTION

The disclosure is now described with respect to its particular embodiments, with reference to the accompanying figures. In the following figures and description, equal or corresponding parts are marked with equal reference numbers.

The figures are schematic and their dimensions and proportions are exemplary, as they are only intended to describe the disclosure in order to facilitate understanding and do not impose any limitations beyond those defined by the appended claims.

The present disclosure deals with a system that uses CAN (Controller Area Network) serial communication bus, namely CAN bus, and wireless communication modules to transmit an instruction from a user to a peripheral device 16 in a row unit.

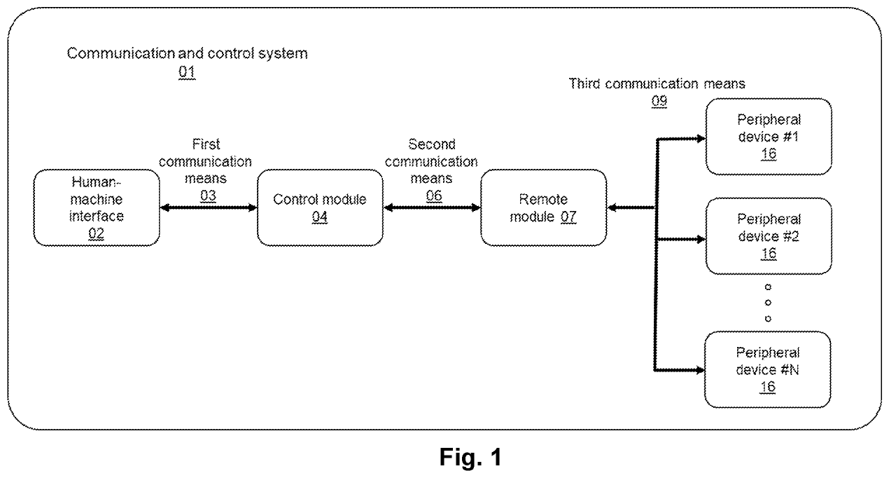

FIG. 1 illustrates a general diagram of an embodiment of the disclosure that shows the communication relationship between the elements of the communication and control system 1 of peripheral equipment 16 of agricultural implements. More specifically, FIG. 1 shows that the human-machine interface 2 and the control module 4 have a communication established through a first communication means 3, the control module 4 and the remote module 7 have communication established through a second communication means 6 and the remote module 7 establishes communication with the peripheral device 16 through a third communication means 9.

In particular, the third communication means 9 of the present disclosure provides for communication between a remote module 7 and a plurality of peripheral devices 16, whereby the peripheral devices 16 can be of different types and with different functions. So that a remote module 7 can interact with one of the peripheral devices 16 without interfering with the operation of the other peripheral devices 16.

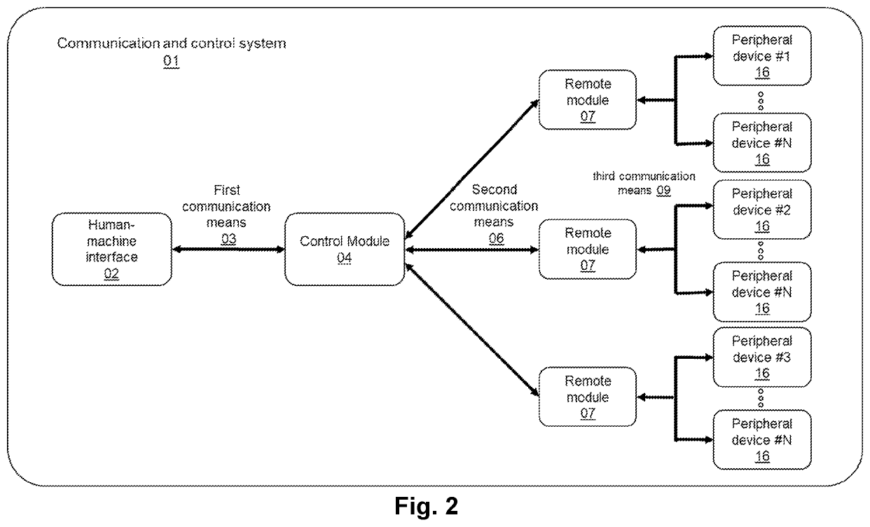

FIG. 2 illustrates a general diagram of another embodiment of the disclosure, in which the control module 4 has communication established through the second communication means 6 with more than one remote module 7 and each remote module 7 is in communication with their respective peripheral devices 16 via the third communication means 9.

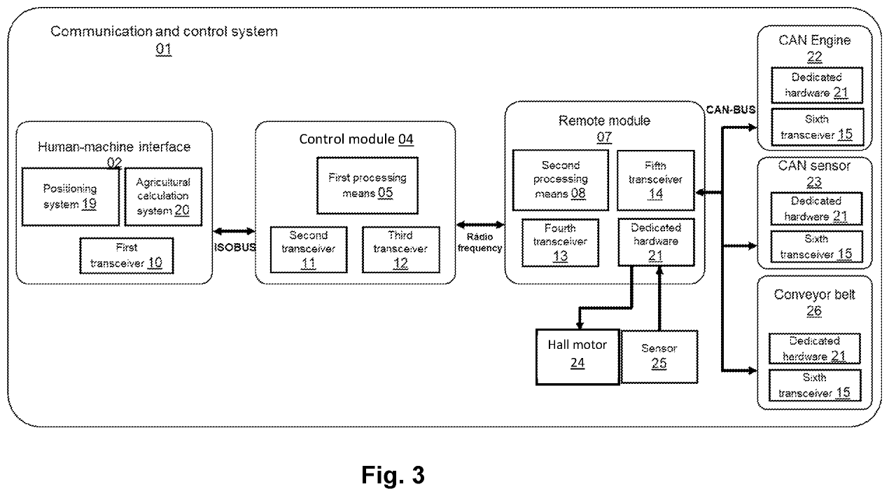

FIG. 3 illustrates a detailed diagram of an embodiment of the disclosure in which the first communication means 3 uses an ISOBUS, the second communication means 6 is a radio frequency wireless means and the third communication means 9 uses a CAN bus.

More specifically, in the embodiment of FIG. 3, the first communication means 3 has a first transceiver 10 at the human-machine interface 2 communicating via ISOBUS with a second transceiver 11 on the control module 4. As an alternative to the ISOBUS standard, the first communication means 3 can use CAN-BUS or other proprietary protocols.

In FIG. 3 it can also be seen that the Control Module 4 includes a first processing means 5 and a third transceiver 12. The third transceiver 12 is part of the second communication means 6 together with the fourth transceiver 13 included in the remote module 7. In this embodiment, the control module 4 interprets the ISOBUS message received by the second transceiver 11, processes the received ISOBUS message and generates a new command message that is sent by the third transceiver 12 wirelessly to the remote module 7 through the fourth transceiver 13.

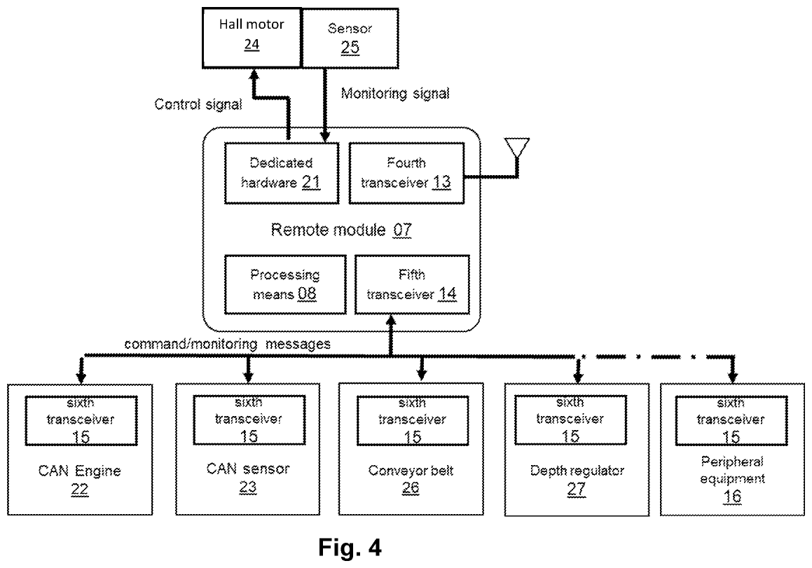

Still in the embodiment of FIG. 3 and in more detail in FIG. 4, the remote module 7 includes a second processing means 8, a fifth transceiver 14 and a dedicated hardware for signal communication 17.

The fifth transceiver 14 is part of the third communication means 9 and communicates with a sixth transceiver 15 on each of the peripheral devices 16 of the plurality of peripheral devices 16 that can be used simultaneously in the system 1 of the present disclosure. The third communication means 9 is used when the peripheral device 16 operates by message 18 such as, for example, a smart actuator 22, such as a CAN engine, or a smart sensor 23, such as a CAN sensor, also known as “smart devices”.

The dedicated hardware of the remote module 7 is used to communicate with peripheral devices 16 that operate by signals. More specifically by way of example, an actuator 24, such as a Hall motor, which operates by receiving a control signal 17a from dedicated hardware 21 or a sensor 25 that sends a monitoring signal 17b to dedicated hardware 21.

A person skilled in the art will readily appreciate that the fifth transceiver 14 and the dedicated hardware 21 are described together as an example in this embodiment of the disclosure, but do not necessarily work together, only the fifth transceiver 14 or the dedicated hardware 21 can be used without prejudice to the operation of the communication and control system 1. Likewise, the communication and control system 1 of the present disclosure allows the use of both types of communication simultaneously without one interfering in the operation of the other, with the fifth transceiver 14 being used when the peripheral device 16 operates by message 18 and the dedicated hardware 21 is used when the peripheral device 16 operates with a control or monitoring signal 17.

FIG. 4 still illustrates some examples of smart devices that can use the third communication means 9, being a smart seed meter 22, a conveyor belt 26, a depth regulator 27 and a smart seeds sensor 23, among other agricultural devices.

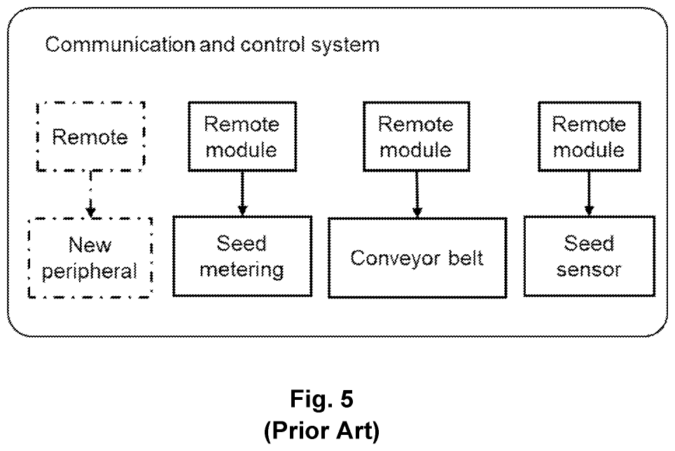

In addition, the system 1 of the present disclosure advantageously allows the inclusion of new peripheral devices 16 not foreseen during the design and manufacture of the row unit, simply installing the new peripheral device 16 and starting communication with a remote module 7 via the third communication means 9. Unlike what is known in the prior art where only one peripheral device (previously foreseen) is installed per module, the system of the present disclosure allows a new peripheral device 16 to be included in the system taking advantage of a remote module 7 already installed in the row unit, as can be seen in the comparison of FIG. 5.

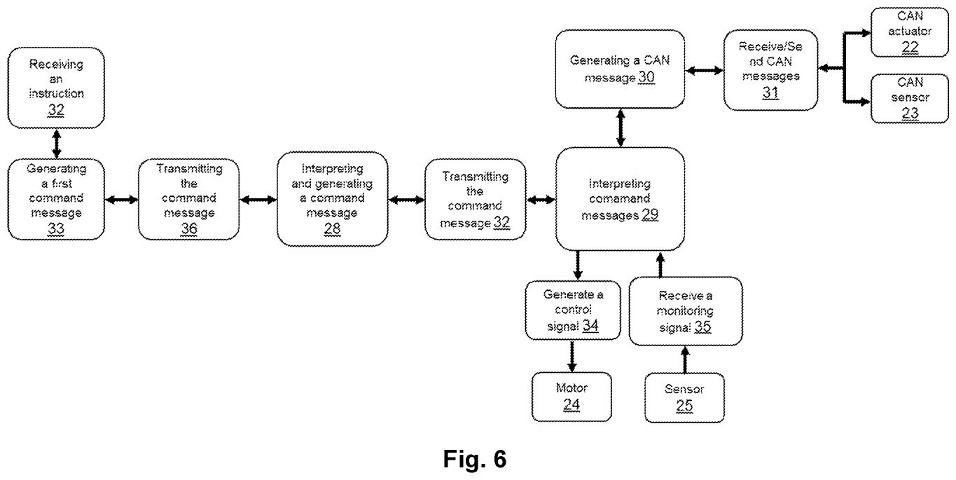

The present disclosure also provides a method of communication and control of peripheral devices 16 applied in agricultural implements, as illustrated in FIG. 6, in which: a user enters an instruction into a human-machine interface 2, which processes the instruction; and generates a message, preferably an ISOBUS message; and sends the message to a control module 4; the control module 4 processes the message to interpret the instruction and generate a wireless command message; the message is sent from the control module 4 to a remote module 7 by means of wireless communication; then the remote module 7 receives the wireless message, processes the message to interpret the instruction; and if the instruction is intended for a smart peripheral device, a message is generated, preferably CAN, and sent to the peripheral device; or if the instruction is intended for a simple control peripheral device, such as a Hall motor, a control signal is generated and sent to the peripheral device; or if the instruction is intended for a simple monitoring peripheral device, such as a seed sensor, a monitoring signal is received which is processed in the remote module 7.

Thus, based on its unique characteristics, it is noted that the present disclosure presents advantages and overcomes the drawbacks of prior art.

While the disclosure has been specifically described with respect to particular embodiments, it is to be understood that variations and modifications will be apparent to those skilled in the art and may be made without departing from the scope of protection of the present disclosure. Consequently, the scope of protection is not limited to the described embodiments, but is limited only by the appended claims, the scope of which must include all equivalents.

1. A communication and control system for peripheral equipment for agricultural implements, comprising:
a human-machine interface;
a first communication means;
a control module;
a first processing means;
a second communication means;
a remote module;
a second processing means; and
a third communication means.

2. The system of claim 1, wherein the first communication means comprises a first transceiver at the human-machine interface in communication with a second transceiver of the control module.

3. The system of claim 2, wherein the second communication means comprises a third transceiver in the control module in communication with a fourth transceiver in the remote module.

4. The system of claim 3, wherein the third communication means comprises a fifth transceiver in the remote module in communication with a sixth transceiver in one or more peripherals.

5. The system of claim 1, wherein the first processing means and the second processing means can generate control signals and messages.

6. The system of claim 1, wherein the third communication means transmits a message to the peripheral equipment.

7. The system of claim 1, wherein at least one of the first, second, or third communication means comprises an electromagnetic information transmission system.

8. The system of claim 7, wherein the electromagnetic information transmission system comprises a radiofrequency electromagnetic information transmission system.

9. The system of claim 8, wherein the radiofrequency electromagnetic information transmission system uses at least one of the following protocols: Bluetooth, Wi-Fi, Lora, Sigfox, proprietary protocol, or mobile networks.

10. The system of claim 1, wherein the first communication means uses the ISOBUS, CAN-BUS, or a proprietary protocol.

11. The system of claim 4, wherein the one or more peripherals comprise at least two peripherals, wherein the at least two peripherals comprise at least one of an actuator, a sensor, a smart sensor, or a smart actuator.

12. The system of claim 11, wherein the smart actuator comprises a CAN engine.

13. The system of claim 11, wherein the actuator comprises an engine mounted in one of a seed meter, a particulate or liquid material meter, a depth regulator, a conveyor belt or a row unit lifting system.

14. The system of claim 1, wherein the human-machine interface comprises a positioning system and an agricultural calculation system.

15. The system of claim 1, wherein the control module comprises a positioning system and the first processing means.

16. The system of claim 1, wherein the remote module comprises the second processing means.

17. The system of claim 1, wherein at least one of the first, second, or third communication means is a 2.4 Ghz RF communication with a proprietary protocol.

18. The system of claim 1, wherein the remote module is connected to a Hall motor, an encoder sensor of the Hall motor, and a CAN-BUS with at least one of a CAN engine or a CAN sensor.

19. The system of claim 18, wherein the CAN engine controls a conveyor belt.

20. The system of claim 18, wherein the CAN sensor detects the passage of seeds.

21. A method of communication and control of peripheral equipment applied to agricultural implements, comprising:
receiving an instruction in a human-machine interface;
generating a first command message;
transmitting the first command message to remote modules;
interpreting the first command message in the remote modules; and
when the peripheral equipment is a smart actuator,
generating a message; and
sending the message to the smart actuator;
when the peripheral equipment is a smart sensor,
receiving a message, generated by the smart sensor, in the remote module; and
interpreting the message from the smart sensor; and
when the peripheral equipment is a simple control device,
generating a control signal when the peripheral equipment is an actuator; and
receiving a monitoring signal when the peripheral equipment is a sensor.

22. The method of claim 21, further comprising:
transmitting the first command message to a control module;
interpreting the first command message and generating a second command message;
transmitting the second command message to the remote modules; and
interpreting the second command message in the remote modules.

23. The method of claim 22, wherein the first and second command messages are wireless command messages.

24. The method of claim 21, wherein the instruction is an ISOBUS message.

25. The method of claim 21, further comprising:
obtaining positioning information through a positioning system;
obtaining an instruction via an agricultural calculating machine; and
generating and transmitting a command message.
